(19) United States
(12) Patent Application Publication
(10) Pub. No.: US 2007/0143195 A1
(43) Pub. Date: Jun. 21, 2007

(54) Systems and methods for evaluating terms of a deal to purchase a vehicle

(76) Inventors: Ryan B. Bell, Plano, TX (US); Christopher S. Allmon, Dallas, TX (US); Mark D. Matz, Allen, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/300,519

(22) Filed: Dec. 15, 2005

(51) Int. Cl. G06Q 40/00

(52) U.S. Cl. 705/35

(57) ABSTRACT

Systems and methods provide advice to a customer that is purchasing a vehicle. For example, a customer may use a hand-held device while at a dealership, or use a computer, to enter terms of a deal, such as financing information. The customer may use the device to send the information electronically to a remote system associated with a financing company. The system evaluates the deal and returns information to the customer via the device indicating whether the deal is fair. Furthermore, the system may also transmit to the customer a report indicating how to improve the deal for the customer.

### TECHNICAL FIELD

Embodiments consistent with the present invention provide systems and methods for analyzing terms of a deal to purchase a vehicle. In particular, embodiments consistent with the present invention analyze terms of the deal, such as the cost of the vehicle, any financing information, a trade-in amount, and any backend products, and transmits advice to a potential buyer.

### BACKGROUND

When shopping for a vehicle, a customer must often digest a large volume of information and costs that comprise a deal for the purchase of the vehicle. Although the customer must rapidly analyze the terms of the deal, during a purchasing process, the customer frequently does not have a means to determine whether all of the terms are reasonable. For example, a customer may have researched the cost of the vehicle ahead of time, and may have a general idea of the manufacturer's suggested retail price (MSRP), the invoice price, and even the market price for the vehicle in a particular region. However, when faced with the selections that are available on a dealership's lot, the customer may have to factor in additional options or may be interested in a different variation of a particular model or a different vehicle altogether.

Moreover, a vehicle purchase transaction may also include additional terms beyond the purchase price, such as financing information, a trade-in value, and various backend products, including, for example, insurance, warranties, and other additions or modifications to the vehicle. As one example, the customer may not be aware of incentives that are offered by the manufacturer for vehicles sold in the customer's region. As another example, during a purchase transaction, a salesperson may provide the customer with financing information for the vehicle. However, the customer may not be savvy enough to determine whether an interest rate of the loan is reasonable. As yet another example, a customer may also not have researched the trade-in value of the customer's current vehicle. With regard to backend products, the customer may not have the means to determine whether an insurance or warranty offering is a good deal or is priced excessively.

Accordingly, there is therefore a need for systems and methods that provide a customer advice regarding the reasonableness of an overall deal. Furthermore, there is a need for mechanisms that identify which terms of a deal are not reasonable so that the customer can negotiate a better price or adjust terms of a transaction Still further, in the event of a reasonable deal, there is a need to identify for the customer which terms of the deal, while reasonable, have room for further negotiation. Such systems and methods would provide the customer with a better understanding of a purchase transaction in real-time so that the customer can make a complete and informed decision.

### SUMMARY

Consistent with an embodiment of the present invention, a method is provided for evaluating a deal to purchase a vehicle by a customer. The method comprises receiving, at a server, one or more terms of the deal to purchase the vehicle from a device operated by the customer; evaluating, by the server, the one or more terms of the deal; rating, by the server, the deal based on the evaluation; and providing, by the server, the rating of the deal to the device during a purchase transaction for the vehicle by the customer.

Consistent with another embodiment of the present invention, a system is provided for evaluating a deal to purchase a vehicle for a customer. The system comprises a device operated by the customer; and a server. The server receives one or more terms of the deal to purchase the vehicle from the device, analyzes the one or more terms of the deal, determines a rating of the deal, and provides the rating to the device during a purchase transaction for the vehicle by the customer.

Consistent with yet another embodiment of the present invention, a computer readable medium stores instructions that evaluate a deal to purchase a vehicle according to a method. The method comprises receiving, at a server, one or more terms of the deal to purchase the vehicle from a device operated by the customer; evaluating, by the server, the one or more terms of the deal; rating, by the server, the deal based on the evaluation; and providing, by the server, the rating of the deal to the device during a purchase transaction for the vehicle by the customer.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention. In the drawings:

FIG. 1 is a diagram of an exemplary system for analyzing terms of a deal to purchase a vehicle, consistent with an embodiment of the present invention;

FIG. 2 is a flow chart of an exemplary method for providing a vehicle buying coach/adviser to a customer, consistent with an embodiment of the present invention;

FIG. 3 is a flow chart of an exemplary method for obtaining data from a customer, consistent with an embodiment of the present invention;

FIG. 4 is a flow chart of an exemplary method for analyzing terms of a deal, consistent with an embodiment of the present invention; and

FIG. 5 is a flow chart of an exemplary method for providing analysis of a vehicle deal to a customer, consistent with an embodiment of the present invention.

### DESCRIPTION OF THE EMBODIMENTS

Embodiments consistent with the present invention provide systems and methods that advise a customer purchasing a vehicle. A customer may use a handheld device or a computer during the purchase to enter terms of a deal (e.g., financing information, etc.). Using the device, the customer may transmit the information electronically to a remote computer system. The system evaluates the terms of the deal and transmits a decision to the customer indicating whether the deal is fair. Furthermore, the system may also transmit to the customer a report that identifies one or more terms of the deal that may be improved and/or are unreasonable. In one embodiment, the report may provide information regarding the price of the vehicle, vehicle financing, trade-in value, and backend products, such as warranties, insurance, and other add-ons associated with the vehicle. Additional examples of backend products include service warranties, GAP insurance, credit and/or life insurance, automobile insurance, and dealer document and/or processing fees.

For example, in an embodiment consistent with the present invention, a server maintains a database storing data for a financing company. The database may store information pertaining to vehicle pricing, vehicle financing, trade-in values of used vehicles, and information related to other backend products associated with vehicles. Furthermore, the database may store information pertaining to customers of the financing company. The customer information may include customer names, addresses, social security numbers, salary information, and any other customer profile information that a customer may have previously submitted, such as in a loan application. In one example, the database may include terms of a pre-approved loan for customers that have already completed and submitted a loan application, such as a loan amount, an interest rate and term of the loan. In particular, in response to a customer submitting a loan application, the financing company may obtain a credit report and determine whether the customer is eligible to receive a pre-approved loan from the financing company.

In other embodiments consistent with the present invention, a customer may not have submitted a loan application. In such a situation, the customer may use the handheld device, or computer, to input identification information, such as the customer's name, address, social security number, and salary information, etc. Other customers may have an existing account with the financing company (e.g., credit card, checking account, etc.) and therefore may only be required to submit a portion of the information that a new customer would be required to submit.

In another embodiment, the customer may use the handheld device, or computer, to enter identification information. For example, the customer may log onto a website associated with the server and provide a user name and password. Once authorized, the customer may be provided with the option to provide information identifying a vehicle of interest. To identify a vehicle, for example, the customer may enter a vehicle identification number (VIN), the manufacturing year, make, and/or model of a vehicle. If the vehicle of interest is a used vehicle, the customer may provide the mileage of the vehicle and an evaluation of the condition of the vehicle. The customer may also provide the manufacturer's suggested retail price (MSRP) and, if applicable, a price that the customer has negotiated with the dealership or seller. The server may then analyze the submitted information and also retrieve additional information from a central database or other computer systems. The server may execute a software program to determine a reasonable price for the vehicle and whether or not the price is fair based on an analysis of the vehicle information. In response, the server may send to the customer's handled device, or computer, an indication regarding the fairness of the deal. For example, if the deal price for a new vehicle is no more than a threshold value, such as five percent above a fair market value, the server may classify the deal as fair. Alternatively, the server may provide a message that indicates that a certain percentage of customers have received a better deal. Such a statistic may be computed using nationally syndicated data that is purchased by the financing company and stored in the database.

In another embodiment, the customer may also provide financing information for evaluation by the server. For example, the customer may send to the server a loan amount, interest rate, and time period for repayment of the loan. Based on this information, the server may determine whether the customer has received a fair financing offer. In other embodiments consistent with the present invention, the customer may supply a monthly payment amount so that the loan may be evaluated. To determine whether a customer has received a fair financing offer, the server may run a credit check to determine the customer's FICO score. A FICO score provides a likelihood that a credit user will pay debts. The customer may be advised that persons having a similar FICO score have received a particular interest rate. Furthermore, the server may allow the customer to submit a loan application to multiple lenders. Once the applications are evaluated, the interest rates and terms of the loans offered by the lenders may be transmitted to the customer. In a situation where the customer does not know the interest rate being offered by a lender, the customer may input an interest rate or monthly payment terms so that the deal can be evaluated.

In addition, the server may provide a financial advisor or buying coach feature. Based on a customer's financial situation, the server may provide further advice similar to a financial advisor. For example, the server may use annual income or an amount of a monthly mortgage payment to determine a percentage of monthly income that the customer can afford to allocate to a vehicle loan. The server may analyze the customer's ZIP code, any credit card debt, number of dependents, or may determine a debt to income ratio and compare the ratio to national averages to advise how much the customer can afford for a vehicle.

The server may also evaluate a trade-in value of the vehicle. For example, the server may determine whether an amount being offered by a dealership for trade-in is fair by considering whether the offer is within a threshold value, such as ten percent of an average value of the vehicle. To obtain trade-in values, the server may store internal data in a database or access data over a network that provides wholesale values at auction.

The server may also evaluate any backend products that the customer has considered purchasing. For example, the customer may provide information concerning warranties, insurance, and other add-ons to the deal. The server may then evaluate these terms of the deal and advise whether the customer is receiving a fair price with respect to the backend terms.

Furthermore, the server may separately evaluate each component of the deal, such as vehicle cost, financing for a loan, trade-in value, or backend products. For example, a customer may receive an evaluation of any one or more of the terms. The customer may also receive an evaluation of the entire deal, including any one or more of the terms. In embodiments consistent with the present invention, results of the analysis are transmitted from the server to the customer's handheld device or computer, and may indicate whether the deal is fair. Furthermore, the results may indicate which terms of the deal are fair and which are not. Still further, the results may indicate that an overall a deal is reasonable, but that there is room to negotiate on one or more terms. Still further, as another example, the result might indicate that the deal is a particular percentage better than a national average, but that a particular term, such as trade-in value, for example, is even or less than a national average. In various embodiments, deal terms may be rated with a numerical system, such as a ranking on a 1 to 10 scale, with 1 being worst and 10 being best, or using a star ranking system, such as a range of one to five stars. Any type of rating mechanism, however, may be implemented by the disclosed embodiments.

Furthermore, a customer may be provided with an option to initiate a video conference or a teleconference with a human advisor. The human advisor may view all of the data that the customer has entered and may assist by talking the customer through the process.

The customer may also use systems and methods of the present invention to save data for multiple scenarios, such as different vehicles and different dealerships. For example, a customer may visit three dealerships and look at the same vehicle. Later, the customer may retrieve data, request side by side comparisons, and generate reports or analysis comparing the deals. For example, the customer may select two different vehicles to compare side by side or may compare the same vehicle across multiple dealerships, for example.

Reference will now be made to exemplary embodiments of the invention, examples of which are illustrated in the accompanying drawings. Wherever possible, the same reference numbers will be used throughout the drawings to refer to the same or like parts.

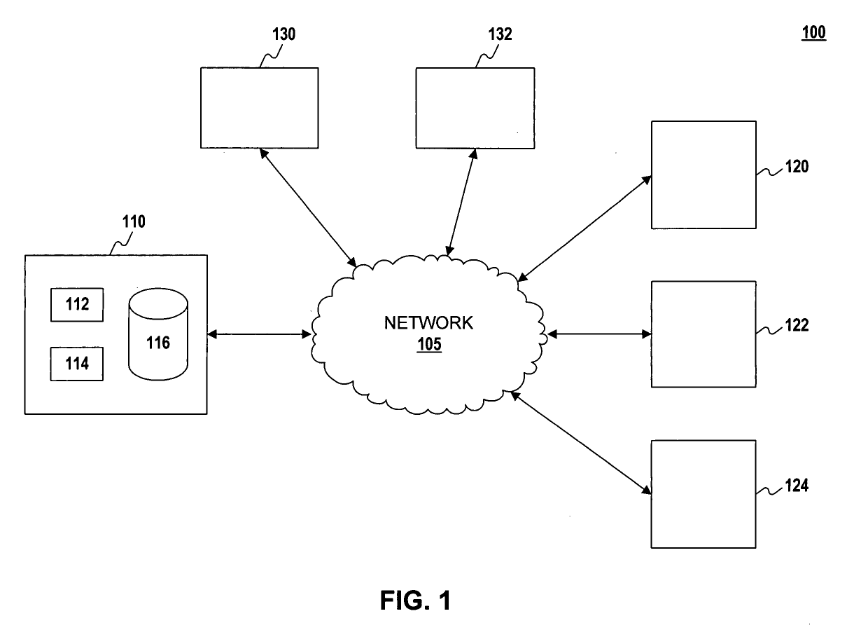

FIG. 1 is a diagram of an exemplary system 100 for analyzing terms of a deal to purchase a vehicle, consistent with an embodiment of the present invention.

System 100 includes a server 110, having a CPU 112, a memory 114, and a database 116. Server 110 may be operated by a financing company that provides vehicle financing services, and is connected to a network 105. Software in memory 114 preferably implements one or more programs for analyzing terms of a deal to purchase a vehicle. For example, memory 114 may store programming modules (not shown) for executing instructions to analyze terms of a deal, such as cost of a vehicle, vehicle financing, trade-in value, and any backend products.

Database 116 may store data pertaining to customers of the financing company and information collected by the financing company used to analyze a deal. For example, database 116 may store data obtained from customers, such as name, address, income, and credit score. This data may be provided by a customer in advance of traveling to a dealership. A customer may provide customer data to server 110 and database 116 electronically via a web site, for example, which may include identification data, a down payment amount for purchase of a vehicle, a trade-in value, etc. Server 110 may retrieve the data from database 116 for performing one or more processes consistent with certain embodiments of the present invention. In other embodiments of the present invention, server 110 may also access one or more external servers (not shown) over network 105 to obtain information that is used to analyze terms of a deal for a customer.

Network 105 provides communications between the various elements in system 100, such as server 110, terminals 120-124, and terminals 130-132. Network 105 may be a shared, public, or private network and may encompass a wide or local area. Furthermore, network 105 may be implemented through any suitable combination of wired and/or wireless communication networks. By way of example, network 105 may be implemented through a wide area network (WAN), local area network (LAN), an intranet, or the Internet.

Terminals 120-124 allow a customer to send and/or receive information to and from server 110. Terminals 120-124 may be any type of computing device for communicating with server 110 over network 105. For example, terminals 120-124 may be a desktop computer, a portable wireless device such as a PDA running a program for communicating with server 105, a cellular phone, or any appropriate handled device, such as a Blackberry. Furthermore, terminals 120-124 may execute a web browser or similar software that allows a customer to exchange information with server 110.

Terminals 130 and 132 may represent computer systems used by customer service representatives associated with the financing company to provide advice to customers. The advice may be similar to the advice described above in connection with server 110. For example, a customer service representative at terminal 130 may access data stored in server 110 to provide advice to a customer at terminal 120 concerning a deal.

Accordingly, as described with respect to FIG. 1, system 100 provides an arrangement whereby server 110 may communicate over network 105 with customers at terminals 120-124 and customer service representatives at terminals 130 and 132. Server 110 may store include software modules designed to analyze terms of a deal and stores information used to analyze terms of a deal.

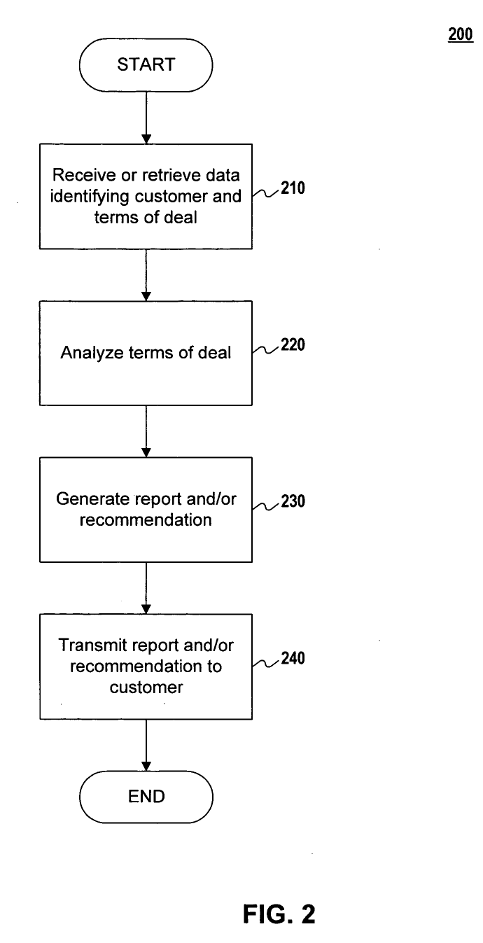

FIG. 2 is a flow chart 200 of an exemplary method for providing a vehicle buying coach or adviser to a customer, consistent with an embodiment of the present invention. In the method shown in flow chart 200, a customer and terms of a deal are identified. Furthermore, the terms of the deal are analyzed, a report or recommendation is generated, and the report or recommendation is transmitted to the customer.

In step 210, server 110 receives or retrieves data identifying a customer. Data identifying a customer may be transmitted from one of terminals 120-124, for example, and may include a user name or password. Alternatively, for example, a customer may be identified based on a cell phone number, an e-mail address, etc. Server 110 may optionally retrieve additional information from database 116 identifying the customer, such as a customer profile, based on the received customer information. Server 110 may also receive terms of a deal to purchase a vehicle. In one example, deal terms may include the purchase price of a vehicle along with information associated with the vehicle. In other examples, the terms of the deal may include additional terms, such as financing information, trade-in information, information regarding any backend products, etc.

In step 220, server 110 analyzes the terms of the deal. When analyzing the terms of the deal, server 110 may access information stored in database 116 and/or access information from an external computer (not shown) over network 105. For example, server 110 may evaluate a vehicle cost by comparing information received from the customer in step 210 with information stored in database 116. Any incentives, such as manufacturer's rebates, that are available may also be taken into consideration when determining the cost.

Furthermore, server 110 may evaluate financing information specifying terms of a loan. Terms of a loan may include an amount borrowed, an interest rate, and a time period for repayment of the loan. Financing information for a particular customer may have been previously stored in database 116 based on an application completed by the customer. In other embodiments, the customer may enter financing information at one of terminals 120-124 and transmit the information to server 110.

Still further, server 110 may analyze terms of a trade-in. A trade-in may be evaluated by examining vehicle make, model, year, condition, etc. Information pertaining to a trade-in may be retrieved from database 116 or may be transmitted by the customer. Server 110 may also access remote computer systems to analyze the trade-in terms. For example, server 110 may access a website provided by a service that evaluates trade-in values. Server 110 may receive the trade-in value for the customer's vehicle from the remote computer system.

Server 110 may also evaluate backend products by retrieving data from database 116 and analyzing information provided by the customer that identifies the backend products. For example, a backend product, such as insurance, may be analyzed when the customer provides a premium and terms of coverage. A backend product such as a warranty may be analyzing by using a cost of the warranty and terms of coverage. Other types of backend products may be analyzed by server 110, and the above examples are not intended to be limiting.

In step 230, server 110 may generate a report and/or recommendation. For example, a customer may have previously selected to receive a report summarizing the terms of the deal and evaluating each term of the deal. Alternatively, or additionally, the customer may have selected to receive an overall evaluation of the deal indicating whether the deal is fair. Still further, the customer may receive a full report as well as an overall recommendation. When a report and/or recommendation includes an evaluation that a deal or a deal component is unreasonable, server 110 may also specify ways to improve the deal by adjusting certain terms of the deal. Improving a deal for a customer may include analyzing one or more terms of the deal to compare the cost to the customer with an expected cost, such as a fair market value. For example, server 110 may generate and transmit a message indicating that the cost of the vehicle is high for a particular geographical region and suggest that the customer try to negotiate the vehicle cost to a more reasonable specified price.

In step 240, the report and/or recommendation is transmitted by server 110 over network 105 to one of terminals 120-124 operated by the customer. At one of terminals 120-124, the report and/or recommendation may be shown on a display, such as an LCD screen of a handheld device. Terminals 120-124 may provide the customer an option to store the report and/or recommendation in a local storage device. Further, terminals 120-124 may provide the customer an option to compare reports for multiple vehicles and/or dealerships, as is discussed below in further detail.

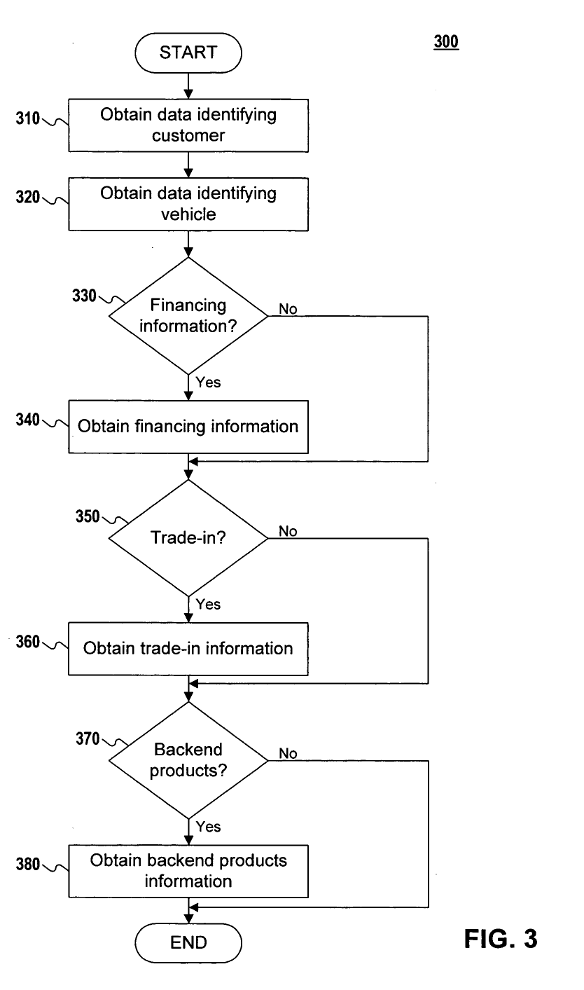

FIG. 3 is a flow chart 300 of an exemplary method for obtaining data from a customer, consistent with an embodiment of the present invention. Flow chart 300 describes the process associated with step 210 of FIG. 2.

In step 310, server 110 obtains data identifying the customer. The customer identifying data may be transmitted from one of terminals 120-124 and may include a user name or password. Alternatively, a customer may be identified based on a cell phone number or other identifier transmitted by one of terminals 120-124. In one embodiment, a customer may log into a website by supplying a user name or password using one of terminals 120-124. Alternatively, a customer may be identified by an Internet protocol (IP) address.

Server 110 may also optionally retrieve additional information identifying the customer, such as a customer profile, based on the received information. For example, based on a user name, server 110 may retrieve from database 116 a customer profile, which includes information identifying the customer. The customer profile may include further identification information, such as address, income, social security number, and may also include information pertaining to any accounts that the customer holds with the financing company operating server 110. Furthermore, any loan applications that a customer has completed may be included in the customer profile.

Next, in step 320, server 110 obtains data identifying a vehicle of interest. In one embodiment, the data identifying the vehicle interest may include a VIN of the vehicle. Using the VIN, server 110 may access a dealership management system (DMS) server, which includes information pertaining to the vehicle and its cost. Alternatively, the customer may supply information to server 110 identifying the vehicle, such as make, model, and year. Furthermore, using one of terminals 120-124, the customer may select specifications of the vehicle, such as trim and other vehicle options. In one example, the terminals 120-124 used by the customer may execute software that presents a list of specifications of a selected vehicle. The customer may select the specifications from the list, which are sent to server 110. Server 110 may take into consideration incentives, such as manufacturer's rebates, when determining the cost. Accordingly, terminals 120-124 may transmit over network 105 information identifying the vehicle of interest to server 110.

In step 330, server 110 determines whether the customer would like to have financing information analyzed. If the customer wishes to have financing information analyzed, the process proceeds to step 340. On the other hand, if the customer does not want to have financing information analyzed, then the process proceeds to step 350.

In step 340, financing information is obtained by server 110. Financing information may be obtained directly from the customer via terminals 120-124 or by retrieving financing information from database 116 of server 110. For example, a customer at terminal 120 may enter financing information, such as an interest rate and a time period for repayment of the loan. However, in a situation where the customer does not know the interest rate, the customer may provide via terminal 120 a monthly payment amount, a time period for repayment, or a specified number of payments. Based on the payment information, server 110 may then determine an interest rate. Further, if the customer has already submitted a loan application with the financing company, server 110 may retrieve the customer's loan information.

Still further, the customer may request server 110 to submit a loan application to one or more lenders. For example, in one embodiment, a customer at terminal 120 may input information for a loan application. The information is transmitted over network 105 to server 110. Server 110 may then submit the loan application to one or more lenders over network 105 for processing by each of the lenders. Once a decision on a loan application is returned to server 110, server 110 may save the decision with the customer's profile in database 116.

In step 350, server 110 determines whether the customer would like to have a trade-in analyzed. If the customer wishes to have a trade-in analyzed, the process proceeds to step 360. If the customer does not want to have a trade-in analyzed, then the process proceeds to step 370.

In step 360, server 110 receives information pertaining to a trade-in from a customer at one of terminals 120-124. The information may include the year, make, model, and condition of the vehicle. The information may also include a monetary amount that a dealership has offered for the trade-in vehicle. Alternatively, server 110 may retrieve trade-in information previously provided by the customer using techniques consistent with the embodiments described above.

In step 370, server 110 determines whether the customer would like to have one or more backend products analyzed. If the customer wishes to have one or more backend products analyzed, the process proceeds to step 380. If the customer does not want to have one or more backend products analyzed, then the process ends.

In step 380, server 110 receives information pertaining to one or more backend products from a customer at one of terminals 120-124, such as warranties, insurance, and other add-ons. Alternatively, server 110 may retrieve from database 116 trade-in information previously provided by the customer.

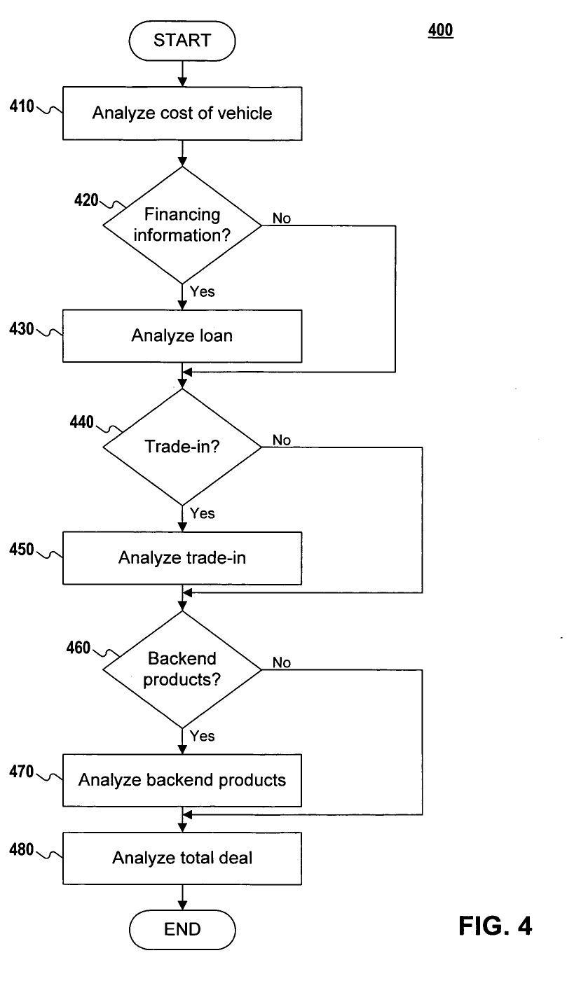

FIG. 4 is a flow chart 400 of an exemplary method for analyzing terms of a deal, consistent with an embodiment of the present invention. In the method shown in flow chart 400, terms of the deal are analyzed with respect to each component and the overall deal is analyzed. One or more terms of the deal or the entire deal may be evaluated.

In step 410, server 110 analyzes the cost of a vehicle. For example, server 110 may evaluate a vehicle cost by comparing information received from the customer with information stored in database 116. Alternatively, vehicle cost may be analyzed by retrieving data from an external computer system over network 105. When analyzing the vehicle cost, server 110 may determine whether a price that a customer has been offered is within a threshold of a fair market value. The fair market value for the vehicle may be obtained from database 116 or from an external system available over network 105. For example, for a new vehicle, if the cost is within a five percent value more than a fair market value, then the cost may be rated “fair.” The offered cost may also be given other ratings, such as, for example, “poor,” “good,” and “excellent” based on its comparison with analyzed costs of the vehicle. Furthermore, the price may be assigned a star, numerical, or any other type of rating.

In step 420, server 110 determines whether the customer requested analysis of any financing information offered during the purchase transaction. If the customer has indicated that financing information should be analyzed, the process proceeds to step 430. If the customer has indicated that financing information should not be analyzed, then the process proceeds to step 440.

In step 430, server 110 may analyze information pertaining to a loan to be used to finance the purchase of the vehicle. Terms of a loan may include an amount borrowed, an interest rate, a time period for repayment of the loan, a number of payments, etc. Server 110 may analyze the financing information with respect to data pertaining to loans given to other individuals having a similar FICO score. For example, data stored in database 116 may indicate interest rates that are typically approved for individuals having certain FICO scores. An interest rate may be compared to an expected interest rate for an individual or a geographic region. Furthermore, the interest rate may be rated (e.g., “fair” and/or assigned a star or numerical rating). The process then proceeds to step 440.

In step 440, server 110 determines whether the customer requested that a trade-in be analyzed. If the customer indicated that a trade-in should be analyzed, the process proceeds to step 450. If the customer did not indicate that a trade-in should be analyzed, then the process proceeds to step 460.

In step 450, server 110 analyzes information pertaining to a trade-in. A trade-in may be evaluated by examining data such as vehicle make, model, year, and condition. Information pertaining to a trade-in may be retrieved from database 116 or may be transmitted by the customer. When analyzing the value of a trade-in, server 110 may determine whether a price that a customer has been offered by a dealership or buyer is within a threshold of a fair market value. The fair market value for the vehicle may be obtained from database 116 or from an external system available over network 105. For example, for a used vehicle, if the price is within a ten percent value below the fair market value, the price may be rated “fair.” The price may be assigned a star, numerical, or any other type of rating. The process then proceeds to step 460.

In step 460, server 110 determines whether the customer requested analysis of one or more backend products. If the customer indicated that one or more backend products should be analyzed, the process proceeds to step 470. If the customer did not indicate that one or more backend products should be analyzed, then the process proceeds to step 480.

In step 470, server 110 may evaluate backend products by retrieving data from database 116 and analyzing information provided by the customer that identifies one or more backend products. For example, a backend product, such as insurance, may be analyzed using a premium data value and terms of coverage. A backend product, such as a warranty, may be analyzed based on a cost of the vehicle and terms of coverage for the warranty. Each cost of a backend product or a group of backend products may be rated (e.g., assigned a star, numerical rating, etc.). The process then proceeds to step 480.

In step 480, server 110 analyzes the total deal. In doing so, server 110 may consider the above described ratings relating to one or more terms of the deal. As discussed above, terms of the deal may include the cost of the vehicle, financing information, trade-in value, and any backend products. In step 480, an average of the ratings may be determined and may be assigned a star or numerical rating. Furthermore, if the total deal is not considered “fair,” or any particular component is not considered “fair,” server 110 may determine areas for improving the deal.

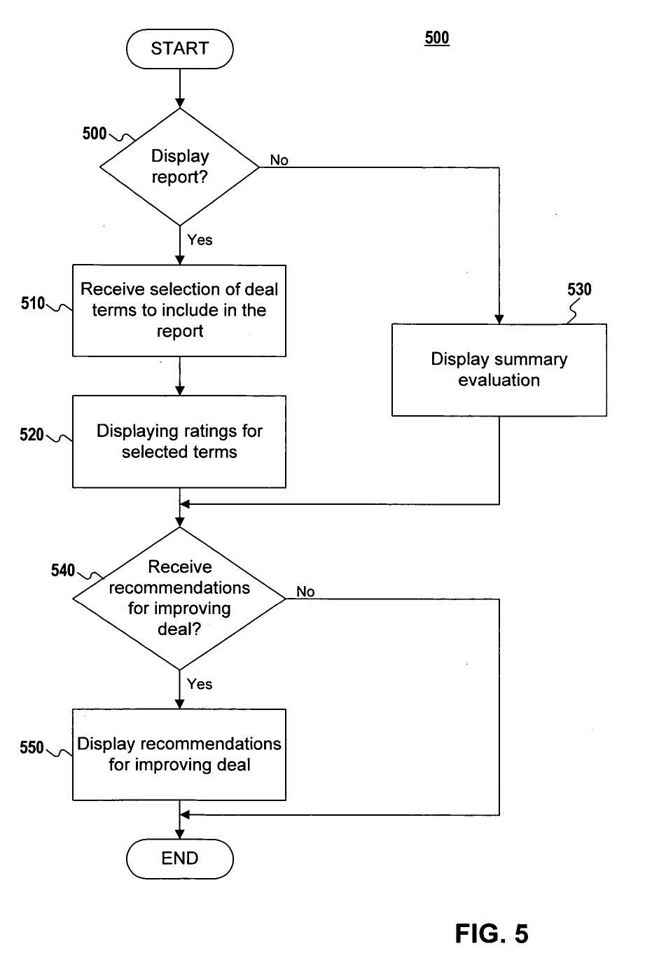

FIG. 5 is a flow chart 500 of an exemplary method for providing analysis of a vehicle deal to a customer, consistent with an embodiment of the present invention. In the method shown in flow chart 500, a customer may select whether to receive a full report and/or a rating of the total deal.

In step 510, a prompt may be displayed on one of terminals 120-124 used by the customer after a deal has been analyzed and/or in response to a customer selection of an option to receive a rating of the deal. In one example, the prompt may inquire whether the customer would like to view a full report. If the customer would like to view a full report, the process proceeds to step 520. If the customer would not like to view a full report, the terminal may display a summary evaluation of a total deal (e.g., the deal is fair or not fair). (Step 530). The process then proceeds to step 550.

When a customer would like to receive a full report server 110 may receive a selection of deal terms to include in the report. (Step 510). In response to the selected terms, server 110 may transmit the rating to one of terminals 120-124 for display. (Step 520).

In step 540, the customer may receive a prompt on one of terminals 120-124 inquiring whether the customer would like to receive recommendations for improving the deal. If the customer would like to receive recommendations for improving the deal, the process proceeds to step 550. If the customer does not want to receive recommendations for improving the deal, the process ends. In step 550, server 110 may generate and/or retrieve advice for improving the deal. For example, the recommendations may indicate that a term is not a good deal (e.g., warranty), but another is (e.g., the vehicle cost is “fair.”). The recommendations may also indicate that the customer should drop the term (such as the warranty) from the deal. Server 110 may then send the recommendation to one of terminals 120-124 for display to the customer.

Accordingly, systems and methods consistent with the invention allow a customer equipped with a wireless device to receive advice pertaining to terms of a deal to purchase a vehicle. A customer may take a hand-held device to a dealership, or use a computer, enter terms of a deal using the device, and send the terms electronically from the device to a remote system associated with a financing company. The system evaluates the deal and transmits a decision to the customer indicating whether the deal is fair. Furthermore, the system may also transmit to the customer a report including an evaluation of the fairness of the deal and/or recommendations for improving the deal. The report may provide information regarding the price of the vehicle, vehicle financing, trade-in value, and backend products, such as warranties, insurance, and other add-ons.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A method for evaluating a deal to purchase a vehicle by a customer, the method comprising:
receiving, at a server, one or more terms of the deal to purchase the vehicle from a device operated by the customer;
evaluating, by the server, the one or more terms of the deal;
rating, by the server, the deal based on the evaluation; and
providing, by the server, the rating of the deal to the device during a purchase transaction for the vehicle by the customer.

2. The method of claim 1, wherein receiving the one or more terms of the deal for the vehicle comprises:
receiving a cost of the vehicle.

3. The method of claim 1, wherein receiving the one or more terms of the deal for the vehicle comprises:
receiving information describing a loan for financing the purchase of the vehicle.

4. The method of claim 3, wherein the information describing the loan includes an interest rate and a time period for repayment of the loan.

5. The method of claim 1, wherein receiving the one or more terms of the deal for the vehicle comprises:
receiving information describing a trade-in vehicle.

6. The method of claim 1, wherein receiving the one or more terms of the deal for the vehicle comprises:
receiving information describing one or more backend products.

7. The method of claim 1, wherein evaluating the one or more terms of the deal comprises:
evaluating whether a cost of the vehicle is within a threshold value of a fair market value.

8. The method of claim 1, wherein evaluating the one or more terms of the deal comprises:
evaluating whether an interest rate of a loan to finance the vehicle is within a threshold value.

9. The method of claim 1, wherein evaluating the one or more terms of the deal comprises:
evaluating whether a trade-in value for a trade-in vehicle is within a threshold value.

10. The method of claim 1, wherein evaluating the one or more terms of the deal comprises:
determining whether one or more terms of the deal may be improved for the customer.

11. The method of claim 1, further comprising:
sending a recommendation to the device including suggestions for the customer to obtain an improved deal for the vehicle.

12. A system for evaluating a deal to purchase a vehicle for a customer, comprising:
a device operated by the customer; and
a server, wherein the server receives one or more terms of the deal to purchase the vehicle from the device, analyzes the one or more terms of the deal, determines a rating of the deal, and provides the rating to the device during a purchase transaction for the vehicle by the customer.

13. The system of claim 12, wherein the one or more terms include a cost of the vehicle.

14. The system of claim 12, wherein the one or more terms includes information describing terms of a loan.

15. The system of claim 12, wherein the one or more terms includes information describing a trade-in vehicle.

16. The system claim 12, wherein the one or more terms includes information describing one or more backend products.

17. The system of claim 12, wherein the server analyzes whether a cost of the vehicle is within a threshold value of a fair market value based on the received one or more terms of the deal.

18. The system of claim 12, wherein the server analyzes whether an interest rate for a loan to finance the vehicle is within a threshold value based on the received one or more terms of the deal.

19. The system of claim 12, wherein the server analyzes whether a trade-in amount for a trade-in vehicle is within a threshold value based on the received one or more terms of the deal.

20. The system of claim 12, wherein the server determines a recommendation to improve the deal for the customer based on the analysis of the one or more terms of the deal.

21. The system of claim 20, wherein the server sends the recommendation to the device during the purchase transaction for the vehicle.

22. A computer readable medium storing instructions that evaluate a deal to purchase a vehicle by a customer according to a method, the method comprising:
receiving, at a server, one or more terms of the deal to purchase the vehicle from a device operated by the customer;
evaluating, by the server, the one or more terms of the deal;
rating, by the server, the deal based on the evaluation; and
providing, by the server, the rating of the deal to the device during a purchase transaction for the vehicle by the customer.

23. The computer readable medium of claim 22, wherein receiving the one or more terms of the deal for the vehicle comprises:
receiving a cost of the vehicle.

24. The computer readable medium of claim 22, wherein receiving the one or more terms of the deal for the vehicle comprises:
receiving information describing a loan for financing the purchase of the vehicle.

25. The computer readable medium of claim 24, wherein the information describing the loan includes an interest rate and a time period for repayment of the loan.

26. The computer readable medium of claim 22, wherein receiving the one or more terms of the deal for the vehicle comprises:
receiving information describing a trade-in vehicle.

27. The computer readable medium of claim 22, wherein receiving the one or more terms of the deal for the vehicle comprises:
receiving information describing one or more backend products.

28. The computer readable medium of claim 22, wherein evaluating the one or more terms of the deal comprises:
evaluating whether a cost of the vehicle is within a threshold value of a fair market value.

29. The computer readable medium of claim 22, wherein evaluating the one or more terms of the deal comprises:
evaluating whether an interest rate of a loan to finance the vehicle is within a threshold value.

30. The computer readable medium of claim 22, wherein evaluating the one or more terms of the deal comprises:
evaluating whether a trade-in value for a trade-in vehicle is within a threshold value.

31. The computer readable medium of claim 22, wherein evaluating the one or more terms of the deal comprises:
determining whether one or more terms of the deal may be improved for the customer.

32. The computer readable medium of claim 22, further comprising:
sending a recommendation to the device including suggestions for the customer to obtain an improved deal for the vehicle.
